(19) United States
(12) Patent Application Publication
(10) Pub. No.: US 2018/0296955 A1
(43) Pub. Date: Oct. 18, 2018

(54) TWO-STAGE MOISTURE SEPARATOR

(71) Applicant: Alupro OY, Tuusula (FI)

(72) Inventors: Vesa SAMELA, Mäntsälä (FI); Juha KIVEKÄS, Espoo (FI)

(73) Assignee: Alupro OY, Tuusula (FI)

(21) Appl. No.: 15/767,578

(22) PCT Filed: Aug. 24, 2016
(86) PCT No.: PCT/FI2016/050578

§ 371 Date: Apr. 11, 2018

(30) Foreign Application Priority Data
Oct. 13, 2015 (FI) 201555723

(51) Int. Cl. B01D 45/04

(52) U.S. Cl. CPC B01D 45/04; F24F 2003/144

(57) ABSTRACT

The invention relates to a two-stage moisture separator for installation at the upper end of a vertical air intake channel (1). The moisture separator comprises a body frame (2) having a square-shaped horizontal cross section, which downwardly smoothly transforms to correspond to the shape of the upper end of the air intake channel (1), so as to be connected thereto in a sealed manner. Each of the sides of the square is provided with a vertically-slatted second separating louver (3), as seen in the direction of air flow, supported to the upper edge of the side. Air channels (4) having an enlarging cross section of flow curve outwardly and downwardly relative to the second separating louvers, and at the ends of the air channels there are, as seen in the direction of air flow, first substantially vertically-slatted separating louvers (5), and suction channels (6) extending downwardly from the first separating louvers. The suction openings (7) of the air channels are substantially downwardly disposed adjacent to the air intake channel (1).

### FIELD OF THE INVENTION

The invention relates to a moisture separator for air intake openings of air intake channels used in different kinds of humid conditions for reducing the humidity of air.

### BACKGROUND OF THE INVENTION

Whether it be different types of motors, buildings, ships, oil platforms or the like, their need of clean air is high and constant. In the inlet air, the relative humidity may in practice vary between 20%-100% and, depending on the circumstances, large amounts of water droplets may be carried in the air to air intake channels.

Traditionally, air has been cleaned and dried with various types of filters; however, these cause such remarkable pressure drops that it is not economically viable to use them, at least where high air flows are involved. Thus, use is currently made, particularly on larger sites, of moisture separators based on a large number of vertical slats, where the air flow travels in a winding manner between the slats, the moisture being condensed into droplets in water collection troughs of the slats.

In general, the structures are large planar surfaces, so there is a clear need to develop smaller water separators with minimized flow resistance, suitable for use in air intake channels of individual multi-story buildings and even individual single-family houses and similar-size sites using small amounts of air.

### OBJECTIVE OF THE INVENTION

The objective of the invention is to remedy the above-mentioned shortcomings of the prior art. Specifically, the objective of the invention is to disclose a new moisture separator which is easily mountable at the upper end of vertical air intake channels, which efficiently removes moisture carried in the air flow, and in which the flow resistance has been minimized.

### SUMMARY OF THE INVENTION

The moisture separator according to the invention is intended for installation and use at the upper end of a vertical and cross-sectionally circular or square-shaped air intake channel. The two-stage moisture separator according to the invention comprises a body frame having a square-shaped horizontal cross section, which downwardly smoothly transforms to correspond to the shape of the upper end of the air intake channel, so as to be connected thereto in a sealed manner. Generally, such smooth transformation means smooth changing of a square cross-sectional shape to a circular shape to correspond to a circular air intake channel. In the square-shaped area of the body frame, supported to the upper edge of each side thereof there is a vertically-slatted second separating louver, as seen in the direction of air flow. Air channels with an enlarging cross-section of flow curve outwardly and downwardly relative to the second separating louvers in a direction opposite to the direction of air flow, and at the ends of the air channels there are, as seen in the direction of air flow, first and substantially vertically-slatted separating louvers. Suction channels extend downwardly from the first separating louvers, the suction openings of which suction channels are substantially downwardly disposed adjacent to the air channel.

Thus, describing the structure in the direction of air flow, in proximity to the upper end of the vertical air channel adjacent to the jacket thereof on the outer side there are, with a regular spacing, i.e. with a spacing of 90 degrees, four downwardly open suction openings. The suction channels extend upwardly from the suction openings, turning outwardly relative to the air channel to such extent that it is possible to install therein, transversely relative to the air flow, the substantially vertically-slatted first separating louvers. The air channels with a tapering cross section of flow extend from the separating louvers, smoothly turning upwardly and horizontally towards one another in the same plane above the upper end of the air intake channel. The air channels from four directions end at the second separating louvers provided with vertical separating slats in the area of the jacket of the air intake channel. Thus, the separating louvers form centrally the upper portion of the square-shaped body frame, which downwardly smoothly transforms to correspond to the shape of the upper end of the air intake channel, so as to be connected thereto in a sealed manner.

As the air channel between the first and the second separating louver has a cross section of flow that tapers in the direction of air flow, it produces an accelerating laminar air flow, whereby water droplets carried in the flow adhere efficiently to the second separating louver. Thus, the structure provides two-stage separation of water, wherein the condensation of moisture into droplets mainly takes place at the first separating louver and in the laminar flow after it, and separation of the droplets from the air flow mainly occurs at the second separating louver.

In one embodiment of the invention the suction channel before the first separating louver has and enlarging cross section of flow.

In one embodiment of the invention, below the downwardly-oriented suction opening there is a closing device for preventing spatters and/or flowing water from entering the suction channel and for closing the suction channel if desired. As the closing device, a buoyant float-type structure may also be used, which automatically rises to a position closing the suction opening if water rises too high in proximity to the suction opening.

In a preferred embodiment of the invention the first separating louver is obliquely angled, such that the angle at which the air flow traveling therethrough rises is 30°-70°. In this range of angles the generally vertically used separating slats still function normally and at the same time the entire structure can be made, in the direction of width, relatively small as compared to both separating louvers being in a fully vertical position.

In one embodiment of the invention on the front side and/or on the rear side of the first separating louver there is an air flow director cell, such as a honeycomb. By means of such a cellular structure, which is known per se, the air flow is arranged to be laminar, vortex-free, so that the separating louver functions even more efficiently.

Preferably above the space having a square-shaped horizontal cross section, formed by the second separating louvers, there is a cover closing the space and a conical flow guide extending centrally in the space downwardly from the cover. The conical structure redirects and guides the horizontal air flow in a smooth and vortex-free manner downwardly towards the air intake channel. In one embodiment of the invention the conical flow guide may be moved vertically such that it functions as a blocking device for the air flow.

### ADVANTAGES PROVIDED BY THE INVENTION

The moisture separator according to the invention brings significant advantages over the prior art. The structure is simple and easily mountable in existing vertical air intake channels. It operates efficiently with a small size and its flow-dynamical properties remain the same in different size classes. Thus, the same structure, just by being correctly sized in terms of flow rates, is directly applicable to suit various needs and size classes in ships, oil platforms and suchlike marine conditions. It may also be used in single-family houses, terraced houses, multi-story buildings and even larger buildings for air intake channels in air conditioning due to its small size, efficient moisture separating capacity and low pressure drops.

### BRIEF DESCRIPTION OF THE DRAWINGS

The invention will now be described in detail with reference to the accompanying drawings, in which

FIG. 1 is a partially sectional oblique top view of one moisture separator according to the invention and

FIG. 2 is a sectional side view of the moisture separator of FIG. 1.

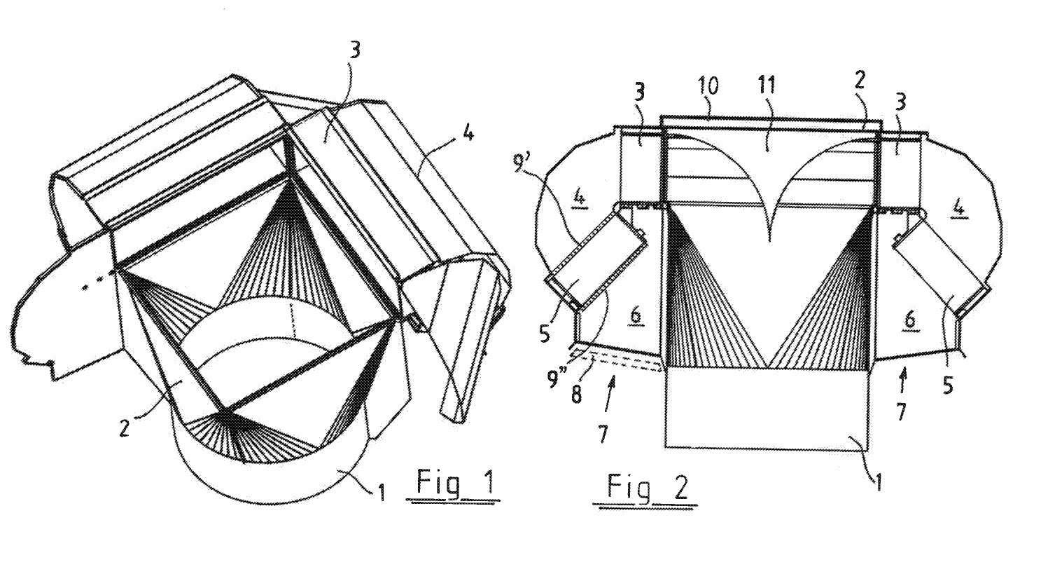

### DETAILED DESCRIPTION OF THE INVENTION

One moisture separator according to the invention as shown in the drawings comprises a body frame 2 having a square-shaped horizontal cross section, which is supported, as it smoothly circularly curves downwardly, to the upper end of a vertical air intake channel 1. Each of the four sides of the body frame 2 is provided with a similar, identical structure. It comprises, as seen from below, i.e. in the direction of air flow, a suction opening 7 which is in proximity to the air intake channel 1 and oriented substantially downwardly. A suction channel 6 extends upwardly from the suction opening and ends at a first separating louver 5 disposed at an oblique angle, i.e. at an angle of approximately 45 degrees.

As known per se, the separating louver 5 consists of a large number of parallel slats having the same profiles, between which the air flows and in the water collection troughs of which slats the moisture and water droplets carried in the air are collected. After the first separating louver 5 the air flow travels on through an air channel 4, turning upwardly and further horizontally towards the air intake channel 1. The cross section of flow of the air channel 4 tapers from the first towards a second separating louver in such a way that an accelerating laminar flow is produced therein, causing droplets to adhere to the surrounding surfaces.

The air channel 4 ends at a second separating louver 3 comprising, similarly to the first separating louver 5, a number of parallel and vertical slats, through which water droplets windingly flow so as to be separated from the air flow. After the second separating louver 3 the air flow reaches the square-shaped body frame 2 closed from the top with a cover 10. A downwardly tapering conical flow guide 11 extends downwardly from the cover 10. It is square in horizontal cross section, and thus it guides smoothly, and with a flow resistance as low as possible, the air flows from each of the four separating louvers 3 in different directions downwardly into the common air intake channel 1.

The moisture separator shown in the drawings functions primarily in two stages, such that the smoothing of air flow and condensation of moisture into droplets take place at the first separating louver 5 and in the accelerating laminar flow after it, and the actual separation of moisture takes place at the second separating louver 3, although it also occurs to some extent already at the first separating louver 5.

Smoothing of the air flow and more efficient droplet formation may be enhanced by installing in front or at the back, or both in front and at the back, of the first separating louver 5 director cells 9′ and 9″. Honeycomb structures are generally used as the director cells, where straight and thin-walled structures with the shape of a regular hexagon smooth the air flow traveling therethrough and decrease the vortices therein.

In addition, the moisture separator may comprise, at the suction openings 7, closing devices 8 by which the air flow to the air intake channel may be prevented. In FIG. 2, the closing device 8 is shown as a schematic representation only, but it may be case-specifically operated in different mechanical, electrical, pneumatic, hydraulic or similar ways. Also, it is possible, for example in marine conditions, to use a structure similar to a buoyant float, automatically rising and closing the suction opening 7 as it is carried by rising water.

While the invention has been described above by way of example with reference to the accompanying drawings, different embodiments of the invention are possible within the scope defined by the claims.

1. A two-stage moisture separator for installation at the upper end of a vertical air intake channel, wherein the moisture separator comprises a body frame having a square-shaped horizontal cross section, which downwardly smoothly transforms to correspond to the shape of the upper end of the air intake channel, so as to be connected thereto in a sealed manner; on each side of the square, supported to the upper edge thereof, a vertically-slatted second separating louver, as seen in the direction of air flow; air channels with an enlarging cross section of flow, curving outwardly and downwardly relative to the second separating louvers; at the ends of the air channels, as seen in the direction of air flow, first substantially vertically-slatted separating louvers; and suction channels extending downwardly from the first separating louvers, the suction openings of which suction channels are substantially downwardly disposed adjacent to the air intake channel.

2. The moisture separator according to claim 1, wherein an accelerating laminar air flow is arranged in the air channel between the first and the second separating louver.

3. The moisture separator according to claim 1, wherein the suction channel arranged before the first separating louver has an enlarging cross section of flow.

4. The moisture separator according to claim 1, wherein below the downwardly-oriented suction opening there is a closing device for preventing the access of spatters and flowing water into the suction channel.

5. The moisture separator according to claim 1, wherein the first separating louver is obliquely angled, such that the angle at which the air flow traveling therethrough rises is 30°-70°.

6. The moisture separator according to claim 1, wherein on the front side and/or on the rear side of the first separating louver there is an air flow director cell, such as a honeycomb.

7. The moisture separator according to claim 1, wherein above the space having a square-shaped horizontal cross section, formed by the second separating louvers, there is a cover closing the space and a conical flow guide extending centrally in the space downwardly from the cover for guiding the air flow from the second separating louvers in a smoothly curving manner downwardly into the air intake channel.

8. The moisture separator according to claim 7, wherein the conical flow guide is moveable in the vertical direction so as to form a blocking device for blocking the air flow to the air intake channel.
